(19) United States
(12) Patent Application Publication
(10) Pub. No.: US 2020/0263780 A1
(43) Pub. Date: Aug. 20, 2020

(54) DEVICE, PLANETARY GEAR WITH A DEVICE AND METHOD FOR CREATING A TORQUE-PROOF CONNECTION BETWEEN TWO STRUCTURAL COMPONENTS

(71) Applicant: Rolls-Royce Deutschland Ltd & Co KG, Blankenfelde-Mahlow (DE)

(72) Inventor: David KRUEGER, Potsdam (DE)

(21) Appl. No.: 16/793,742

(22) Filed: Feb. 18, 2020

(30) Foreign Application Priority Data
Feb. 19, 2019 (DE) 10 2019 104 143.0

(51) Int. Cl. F16H 57/023

(52) U.S. Cl. CPC F16H 57/023; F02C 7/36

(57) ABSTRACT

A device includes two components which are rotationally fixedly operatively connected to one another. One component engages certain regions radially around the other component in an axial direction. Between the components, there is a substantially ring-shaped structural unit by which the rotationally fixed connection is produced. The structural unit includes two elements which extend in a circumferential direction radially between the components. Via the structural unit, there is an interference fit between the radially outer component and the structural unit and between the radially inner component and the structural unit over the entire operating range of the device. The elements bear against one another in the region of their end sides facing toward one another. The coefficient of thermal expansion or the coefficients of thermal expansion of the elements is or are greater than the coefficient of thermal expansion or the coefficients of thermal expansion of the components.

This application claims priority to German Patent Application DE102019104143.0 filed Feb. 19, 2019, the entirety of which is incorporated by reference herein.

The present disclosure relates to a device having two components which are rotationally fixedly operatively connected to one another. The present disclosure furthermore relates to a method for producing a rotationally fixed connection between two components, and to a planetary gear box having a device. The present disclosure additionally relates to a gas turbine engine for an aircraft.

Devices having in each case two components which are rotationally fixedly operatively connected to one another are well known from practice. Here, it is commonly the case that one component engages at least in certain regions radially around the other component in an axial direction of the components. Connecting technology, as it is known, describes the structural methods in the assembly of technical entities, such as machines, installations, apparatuses, appliances and modern structures, from their individual parts. The process of connection is referred to as joining, and falls within the field of manufacturing technology. This generally concerns fixed connections. Connections which merely restrict the mobility between two parts are joints.

The connections are referred to as releasable if the connection can be released again without damage to the components. If the components must be destroyed, the connection is referred to as non-releasable. Additionally considered distinctly are also conditionally releasable connections, if only so-called auxiliary joining parts must be destroyed, but not the components. Furthermore, connections are classified in accordance with physical operating principles. In this context, a distinction is made between positively locking, non-positively locking and cohesive connections. Positively locking connections arise as a result of the engagement of at least two connecting partners into one another. In this way, the connecting partners or components cannot be released even in the absence of power transmission or in the event of an interruption in power transmission.

By contrast to this, non-positively locking connections necessitate a normal force on the surfaces that are to be connected to one another. The mutual displacement thereof is prevented for as long as the opposing force effected by the static friction is not exceeded. The non-positive locking or frictional engagement is lost, and the surfaces slide on one another, if the tangentially acting load force is greater than the static friction force. Such non-positive locking is the cause for the self-locking of loaded wedges or screws. The static friction between the effective surfaces prevents the wedge from sliding out or the screw from beginning to rotate.

Cohesive connections refer to all connections in the case of which the connecting partners are held together by atomic or molecular forces. At the same time, they are non-releasable connections which can be severed only by destruction of the connecting means.

In order to connect cylindrical components rotationally fixedly to one another by means of a non-positively locking connection, use is often made of so-called interference fits. Here, in mechanical engineering, a fit refers to the dimensional relationship between two parts which are intended to fit together without reworking. Normally, at the joining location, said parts have the same contour, one as an internal shape and one as an external shape. A typical example of this is the shaft in a bore. The diameter of the two contours is specified as a dimension provided with a tolerance. Both contours have the same nominal dimension. What differ are the two tolerance fields, within which the respective actual dimension, formed during the manufacturing process, of bore and shaft must lie.

The oversize of such interference fit is defined for the respective usage situation. In the configuration of the oversize of the interference fit, consideration must be given inter alia to effects such as centrifugal and thermal expansions of the components that are to be connected rotationally fixedly to one another.

In order to be able to generate the interference fit to the desired degree, it is for example the case that two cylindrical components are joined together by means of a significant temperature difference. In the case of strong interference fits, this method requires a large temperature difference between the two components to be joined, and/or a very high joining force. The joining force may under some circumstances exceed the elastic limit of the components. The large temperature differences required can under some circumstances be generated not only by cooling of one component or heating of the other component. That is to say, it is necessary for one component to be cooled and for the other component to be heated. Here, the possible temperatures are limited by the respectively used material of the respective component. Under some circumstances, the component cannot be heated to the required temperature in order to permit problem-free joining of the components.

For the case that the desired interference fit cannot be produced, or cannot be produced only by thermal treatment of the components that are to be joined together, it is possible for the desired press fit to be connected rotationally fixedly to one another by means of a ring element, preferably a conical ring, which is to be inserted between the components and which generates the oversize in accordance with the depth to which it is pressed in.

A problem here is however that, for the introduction of a ring-shaped element of said type, high joining forces must be applied, which can however in turn cause damage to the components that are to be connected to one another.

It is sought to provide a device in the case of which a desired oversize of an interference fit can be produced with low joining forces and the smallest possible temperature differences between the components that are to be connected rotationally fixedly to one another. It is furthermore sought to provide a method by means of which an interference fit between two components that are to be connected rotationally fixedly to one another can be implemented with the lowest possible joining forces and the smallest possible temperature differences.

Said object is achieved by means of a device and by means of a method having the features of patent claims 1 and 13 respectively.

According to a first aspect, a device having at least two components that are rotationally fixedly operatively connected to one another is proposed. One component engages at least in certain regions around the other component in an axial direction of the components. Between the components, there is provided a substantially ring-shaped structural unit by means of which the rotationally fixed connection between the components is produced. The structural unit comprises at least two elements which extend in a circumferential direction radially between the components.

The elements bear against one another in the region of their circumferential end sides or radial end sides facing toward one another, and the coefficient of thermal expansion or the coefficients of thermal expansion of the elements is or are greater than the coefficient of thermal expansion or the coefficients of thermal expansion of the components. In this way, by means of the structural unit, an interference fit is produced between the radially outer component and the structural unit and between the radially inner component and the structural unit over the entire operating range of the device.

It is furthermore achieved in this way that the rotationally fixed connection between the two components by means of the ring-shaped structural unit can be produced at low temperatures, for example at room temperature, with low joining forces. Additionally, the oversize between the outer component and the structural unit and the oversize between the inner component and the structural unit increase with rising operating temperatures of the device. This is particularly advantageous if, during the operation of the device, the operating temperature thereof increases in relation to the assembly situation.

Here, in the present case, the expression “circumferential end sides of the elements” is to be understood to mean delimiting surfaces or sides of the elements which face toward one another and in the region of which elements arranged adjacent to one another in the circumferential direction can bear circumferentially against one another in order to be able to provide the desired oversize with simultaneously low joining forces.

By contrast to this, the expression “radial end sides of the elements” relates to those radial outer delimiting surfaces of the elements which delimit the elements in an inward radial direction and in a radially outward direction and which thus constitute in each case radial outer surfaces and radial inner surfaces, respectively, of the elements, in the region of which the elements bear against one another. In this embodiment, the structural unit may be of segmented design both in the circumferential direction and the radial direction. In other words, the structural unit may then have a radially inner ring, which is composed of multiple elements and which is segmented in the circumferential direction, and a radially outer ring, which is composed of multiple elements and which is segmented in the circumferential direction. The elements of the outer ring and of the inner ring then bear against one another in the region of their radial end sides facing toward one another.

Provision may be made whereby the elements are formed with a coating in the region of their end sides which bear against one another. Here, the coating of the end sides may be such that the coefficient of friction in the region of contact between the end sides of the elements is lower than the coefficient of friction between non-coated regions of the elements. It is achieved in this way that the thermally induced sliding of the elements on one another, which increases the joining pressure with rising operating temperature, is impeded to a lesser extent by the friction force that arises here between the elements.

The components can be placed in operative connection with one another with low joining forces and/or with small temperature differences, and the press fit is present over the entire operating range of the device, if a ratio between the coefficients of thermal expansion of the components and of the elements of the structural unit lies in a value range between 0.1 and 0.9.

According to a further aspect of the present disclosure, the circumferential end sides of the elements enclose in each case an angle between 0° and 90°, preferably between 10° and 80°, with a radial outer side of the structural unit and with a radial inner side of the structural unit. In general, the angle of inclination or the wedge angle of the circumferential end sides of the elements is dependent on the intended profile of the magnitude of the joining pressure between the components and the ring-shaped structural unit over the circumference. Here, it is possible for the magnitude of the joining pressure to be approximately constant over the circumference of the components, to vary in continuous fashion at least in certain regions over the circumference, or to increase and decrease again in alternating fashion.

The radial outer side of the structural unit is formed by the radial outer sides of the elements, and the radial inner side of the structural unit is formed by the radial inner sides of the elements of the structural unit.

In general, the wedge angle of the circumferential end sides and also of the radial end sides of the elements, and the component stiffness of the elements, are dependent on the number of elements, on the length of the elements in the radial direction and/or on the axial length of the elements in the presence of axial clamping, and on the thickness of the segments.

If the angle between the radial outer side or end side and a circumferential end side of one of the elements is for example equal to the angle between the radial inner side or end side of the element and the circumferential end side, then the joining pressure in the circumferential direction is substantially constant in said region of the element.

By contrast to this, the joining pressure between the components and the structural unit is variable at least in certain regions in the circumferential direction if the angle between the radial outer side and a circumferential end side of one of the elements differs from the angle between the radial inner side of the element and the end side.

The joining pressure between the components and the structural unit is constant over the circumference of the components in a simple manner in terms of construction if the angles between the circumferential end sides of the elements and the radial outer sides and between the circumferential end sides and the radial inner sides are substantially equal.

If the angles between the circumferential end sides of an element and the radial outer sides and between the circumferential end sides and the radial inner sides differ from one another, then the joining pressure between the components and the structural unit again varies in the circumferential direction in a simple manner.

Here, the joining pressure is also variable in a simple manner by means of the number and the respectively resulting size of the elements in the circumferential direction of the structural unit and by means of the radial thickness of the elements. If the circumferential end sides of the elements enclose relatively small angles with the radial extent direction of the structural unit, the component stiffness thereof in the edge regions thereof is greater than in the case of embodiments of the elements in which the circumferential end surfaces enclose relatively large angles with the radial extent direction of the structural unit.

By contrast to this, however, the overlap region between the respectively adjacent elements decreases in the case of relatively small angles between the circumferential end surfaces and the radial extent direction of the structural unit, whereby, in turn, the thermally induced increase of the joining pressure is smaller.

According to a further aspect of the present disclosure, the structural unit comprises more than two elements, which elements bear against one another in each case in the region of end sides which face toward one another and which delimit the elements in the circumferential direction of the components or end sides which delimit the elements in the radial direction.

If the circumferential end sides of the elements have an arcuate profile at least in certain regions in the radial extent direction of the elements in each case between the radial inner side and the radial outer side, the joining pressure between the components and the structural unit can be set or influenced with a large degree of freedom. Furthermore, it may be possible for changes in stiffness of the elements to be compensated by means of the preferably circular-arc-shaped, parabolic or a corresponding profile, and for a desiredly constant joining pressure to be generated.

In a further embodiment of the device according to the present disclosure, the elements of the structural unit, in the region of their radial outer sides and/or in the region of their radial inner side, which in each case constitute radial end sides of the elements, have a wedge-shaped cross-sectional profile in the axial direction. Then, the oversize of the interference fits between the ring-shaped structural unit and the components can be set by means of the depth to which the structural unit, which is then of wedge-shaped design, is inserted between the two components.

According to a further aspect of the present disclosure, one of the components is a planet carrier of a planetary gear box. The other component, connected rotationally fixedly thereto, may be a bolt on which planet gears of the planetary gear box can be arranged in a rotatable manner and which is arranged in a bore of the planet carrier. The ring-shaped structural unit is then arranged radially between the planet carrier and the bolt, whereby the bolt is positionable in the planet carrier, and connectable rotationally fixedly thereto, with low joining forces and/or with a small temperature difference. It is thereby ensured that the planet carrier is subjected to only low mechanical and thermal loads during the production of the planetary gear box and can be produced with the manufacturing quality required for correct functioning.

The present disclosure furthermore relates to a planetary gear box having a device described in more detail above.

The present disclosure additionally relates to a method for producing a rotationally fixed connection between two components, having the following method steps:
introducing the first component in an axial direction of the components into a bore of the second component;
installing a ring-shaped structural unit as discussed in more detail above in the axial direction of the components into the bore of the second component, wherein the ring-shaped structural unit is introduced before or after the first component into the bore of the second component into the bore.

If the component temperature of the second component is raised in relation to an ambient temperature before the introduction of the first component and of the structural unit into the bore, and/or the component temperature of the structural unit and/or the component temperature of the first component is lowered in relation to the ambient temperature, the rotationally fixed connection between the two components can be produced with low joining forces.

As noted elsewhere herein, the present disclosure may relate to a gas turbine engine. Such a gas turbine engine may comprise an engine core which comprises a turbine, a combustion chamber, a compressor, and a core shaft that connects the turbine to the compressor. Such a gas turbine engine may comprise a fan (having fan blades) which is positioned upstream of the engine core.

Arrangements of the present disclosure can be particularly, although not exclusively, beneficial for fans that are driven via a gear box. Accordingly, the gas turbine engine may comprise a gear box that receives an input from the core shaft and outputs drive for the fan so as to drive the fan at a lower rotational speed than the core shaft. The input to the gear box may be performed directly from the core shaft or indirectly from the core shaft, for example via a spur shaft and/or a spur gear. The core shaft may be rigidly connected to the turbine and the compressor, such that the turbine and the compressor rotate at the same rotational speed (wherein the fan rotates at a lower rotational speed). The gear box herein can be embodied as a planetary gear box as has been described in more detail above.

The gas turbine engine as described and claimed herein may have any suitable general architecture. For example, the gas turbine engine may have any desired number of shafts, for example one, two or three shafts, that connect turbines and compressors. Purely by way of example, the turbine connected to the core shaft may be a first turbine, the compressor connected to the core shaft may be a first compressor, and the core shaft may be a first core shaft. The engine core may further comprise a second turbine, a second compressor, and a second core shaft which connects the second turbine to the second compressor. The second turbine, second compressor, and second core shaft may be arranged so as to rotate at a higher rotational speed than the first core shaft.

In such an arrangement, the second compressor may be positioned so as to be axially downstream of the first compressor. The second compressor may be arranged so as to receive (for example directly receive, for example via a generally annular duct) flow from the first compressor.

The gear box may be arranged so as to be driven by that core shaft (for example the first core shaft in the example above) which is configured to rotate (for example during use) at the lowest rotational speed. For example, the gear box may be arranged so as to be driven only by that core shaft (for example only by the first core shaft, and not the second core shaft, in the example above) which is configured to rotate (for example during use) at the lowest rotational speed. Alternatively thereto, the gear box may be arranged so as to be driven by one or a plurality of shafts, for example the first and/or the second shaft in the example above.

In the case of a gas turbine engine which is described and claimed herein, a combustion chamber may be provided so as to be axially downstream of the fan and the compressor(s). For example, the combustion chamber can lie directly downstream of the second compressor (for example at the exit of the latter), if a second compressor is provided. By way of further example, the flow at the exit of the compressor may be supplied to the inlet of the second turbine, if a second turbine is provided. The combustion chamber may be provided upstream of the turbine(s).

The or each compressor (for example the first compressor and the second compressor as described above) may comprise any number of stages, for example multiple stages. Each stage may comprise a row of rotor blades and a row of stator vanes, the latter potentially being variable stator vanes (in that the angle of incidence of said stator vanes can be variable). The row of rotor blades and the row of stator vanes may be axially offset from one another.

The or each turbine (for example the first turbine and the second turbine as described above) may comprise any number of stages, for example multiple stages. Each stage may comprise a row of rotor blades and a row of stator vanes. The row of rotor blades and the row of stator vanes may be axially offset from one another.

Each fan blade may be defined as having a radial span width extending from a root (or a hub) at a radially inner location flowed over by gas, or at a 0% span width position, to a tip at a 100% span width position. The ratio of the radius of the fan blade at the hub to the radius of the fan blade at the tip may be less than (or of the order of): 0.4, 0.39, 0.38, 0.37, 0.36, 0.35, 0.34, 0.33, 0.32, 0.31, 0.3, 0.29, 0.28, 0.27, 0.26 or 0.25. The ratio of the radius of the fan blade at the hub to the radius of the fan blade at the tip may be in an inclusive range delimited by two of the values in the previous sentence (that is to say that the values may form upper or lower limits). These ratios may be referred to in general as the hub-to-tip ratio. The radius at the hub and the radius at the tip can both be measured at the leading periphery (or the axially frontmost periphery) of the blade. The hub-to-tip ratio refers, of course, to that portion of the fan blade which is flowed over by gas, that is to say the portion that is situated radially outside any platform.

The radius of the fan can be measured between the engine centerline and the tip of the fan blade at the leading periphery of the latter. The diameter of the fan (which can simply be double the radius of the fan) may be larger than (or of the order of): 250 cm (approximately 100 inches), 260 cm, 270 cm (approximately 105 inches), 280 cm (approximately 110 inches), 290 cm (approximately 115 inches), 300 cm (approximately 120 inches), 310 cm, 320 cm (approximately 125 inches), 330 cm (approximately 130 inches), 340 cm (approximately 135 inches), 350 cm, 360 cm (approximately 140 inches), 370 cm (approximately 145 inches), 380 cm (approximately 150 inches), or 390 cm (approximately 155 inches). The fan diameter may be in an inclusive range delimited by two of the values in the previous sentence (that is to say that the values may form upper or lower limits).

The rotational speed of the fan may vary during use. Generally, the rotational speed is lower for fans with a comparatively large diameter. Purely by way of non-limiting example, the rotational speed of the fan under cruise conditions may be less than 2500 rpm, for example less than 2300 rpm. Purely by way of a further non-limiting example, the rotational speed of the fan under cruise conditions for an engine having a fan diameter in the range from 250 cm to 300 cm (for example 250 cm to 280 cm) may also be in the range from 1700 rpm to 2500 rpm, for example in the range from 1800 rpm to 2300 rpm, for example in the range from 1900 rpm to 2100 rpm. Purely by way of a further non-limiting example, the rotational speed of the fan under cruise conditions for an engine having a fan diameter in the range from 320 cm to 380 cm may be in the range from 1200 rpm to 2000 rpm, for example in the range from 1300 rpm to 1800 rpm, for example in the range from 1400 rpm to 1600 rpm.

During use of the gas turbine engine, the fan (with associated fan blades) rotates about an axis of rotation. This rotation results in the tip of the fan blade moving with a speed Uₜᵢₚ. The work done by the fan blades on the flow results in an enthalpy rise dH in the flow. A fan tip loading can be defined as dH/Uₜᵢₚ², where dH is the enthalpy rise (for example the 1-D average enthalpy rise) across the fan and Uₜᵢₚ is the (translational) velocity of the fan tip, for example at the leading periphery of the tip (which can be defined as the fan tip radius at the leading periphery multiplied by the angular speed). The fan tip loading at cruise conditions may be more than (or of the order of): 0.3, 0.31, 0.32, 0.33, 0.34, 0.35, 0.36, 0.37, 0.38, 0.39, or 0.4 (wherein all units in this passage are Jkg⁻¹K⁻¹/(ms⁻¹)²). The fan tip loading may be in an inclusive range delimited by two of the values in the previous sentence (that is to say that the values may form upper or lower limits).

Gas turbine engines in accordance with the present disclosure can have any desired bypass ratio, where the bypass ratio is defined as the ratio of the mass flow rate of the flow through the bypass duct to the mass flow rate of the flow through the core at cruise conditions. In the case of some arrangements, the bypass ratio can be more than (or of the order of): 10, 10.5, 11, 11.5, 12, 12.5, 13, 13.5, 14, 14.5, 15, 15.5, 16, 16.5, or 17. The bypass ratio may be in an inclusive range delimited by two of the values in the previous sentence (that is to say that the values may form upper or lower limits). The bypass duct may be substantially annular. The bypass duct may be situated radially outside the engine core. The radially outer surface of the bypass duct may be defined by an engine nacelle and/or a fan casing.

The overall pressure ratio of a gas turbine engine as described and claimed herein may be defined as the ratio of the stagnation pressure upstream of the fan to the stagnation pressure at the exit of the highest pressure compressor (before the entry to the combustion chamber). By way of non-limiting example, the overall pressure ratio of a gas turbine engine as described and claimed herein at cruising speed may be greater than (or of the order of): 35, 40, 45, 50, 55, 60, 65, 70, 75. The overall pressure ratio may be in an inclusive range delimited by two of the values in the previous sentence (that is to say that the values may form upper or lower limits).

The specific thrust of a gas turbine engine may be defined as the net thrust of the gas turbine engine divided by the total mass flow through the engine. The specific thrust of an engine as described and/or claimed herein at cruise conditions may be less than (or of the order of): 110 Nkg⁻¹s, 105 Nkg⁻¹s, 100 Nkg⁻¹s, 95 Nkg⁻¹s, 90 Nkg⁻¹s, 85 Nkg⁻¹s or 80 Nkg⁻¹s. The specific thrust may be in an inclusive range delimited by two of the values in the previous sentence (that is to say that the values may form upper or lower limits). Such gas turbine engines can be particularly efficient in comparison with conventional gas turbine engines.

A gas turbine engine as described and claimed herein may have any desired maximum thrust. Purely by way of a non-limiting example, a gas turbine as described and/or claimed herein may be capable of generating a maximum thrust of at least (or of the order of): 160 kN, 170 kN, 180 kN, 190 kN, 200 kN, 250 kN, 300 kN, 350 kN, 400 kN, 450 kN, 500 kN, or 550 kN. The maximum thrust may be in an inclusive range delimited by two of the values in the previous sentence (that is to say that the values may form upper or lower limits). The thrust referred to above may be the maximum net thrust at standard atmospheric conditions at sea level plus 15 degrees C. (ambient pressure 101.3 kPa, temperature 30 degrees C.) in the case of a static engine.

In use, the temperature of the flow at the entry to the high-pressure turbine can be particularly high. This temperature, which can be referred to as TET, may be measured at the exit to the combustion chamber, for example directly upstream of the first turbine blade, which in turn can be referred to as a nozzle guide blade. At cruising speed, the TET may be at least (or of the order of): 1400 K, 1450 K, 1500 K, 1550 K, 1600 K, or 1650 K. The TET at constant speed may be in an inclusive range delimited by two of the values in the previous sentence (that is to say that the values may form upper or lower limits). The maximum TET in the use of the engine may be at least (or of the order of), for example: 1700 K, 1750 K, 1800 K, 1850 K, 1900 K, 1950 K, or 2000 K. The maximum TET may be in an inclusive range delimited by two of the values in the previous sentence (that is to say that the values may form upper or lower limits). The maximum TET may occur, for example, under a high thrust condition, for example under a maximum take-off thrust (MTO) condition.

A fan blade and/or an airfoil portion of a fan blade as described herein can be manufactured from any suitable material or a combination of materials. For example, at least a part of the fan blade and/or of the airfoil can be manufactured at least in part from a composite, for example a metal matrix composite and/or an organic matrix composite, such as carbon fiber. By way of further example, at least a part of the fan blade and/or of the airfoil can be manufactured at least in part from a metal, such as a titanium-based metal or an aluminum-based material (such as an aluminum-lithium alloy) or a steel-based material. The fan blade may comprise at least two regions which are manufactured using different materials. For example, the fan blade may have a protective leading periphery, which is manufactured using a material that is better able to resist impact (for example of birds, ice, or other material) than the rest of the blade. Such a leading periphery may, for example, be manufactured using titanium or a titanium-based alloy. Thus, purely by way of example, the fan blade may have a carbon-fiber-based or aluminum-based body (such as an aluminum-lithium alloy) with a titanium leading periphery.

A fan as described herein may comprise a central portion from which the fan blades can extend, for example in a radial direction. The fan blades may be attached to the central portion in any desired manner. For example, each fan blade may comprise a fixing device which can engage with a corresponding slot in the hub (or disk). Purely by way of example, such a fixing device may be in the form of a dovetail that can be inserted into and/or engage with a corresponding slot in the hub/disk in order for the fan blade to be fixed to the hub/disk. By way of further example, the fan blades can be formed integrally with a central portion. Such an arrangement may be referred to as a blisk or a bling. Any suitable method may be used to manufacture such a blisk or such a bling. For example, at least a part of the fan blades can be machined from a block and/or at least a part of the fan blades can be attached to the hub/disk by welding, such as linear friction welding, for example.

The gas turbine engines as described and claimed herein may or may not be provided with a variable area nozzle (VAN). Such a variable area nozzle can allow the exit cross section of the bypass duct to be varied during use. The general principles of the present disclosure can apply to engines with or without a VAN.

The fan of a gas turbine engine as described and claimed herein may have any desired number of fan blades, for example 16, 18, 20, or 22 fan blades.

As used herein, cruise conditions may mean cruise conditions of an aircraft to which the gas turbine engine is attached. Such cruise conditions may be conventionally defined as the conditions at mid-cruise, for example the conditions experienced by the aircraft and/or the gas turbine engine at the midpoint (in terms of time and/or distance) between end of climb and start of descent.

Purely by way of example, the forward speed at the cruise condition can be any point in the range of from Mach 0.7 to 0.9, for example 0.75 to 0.85, for example 0.76 to 0.84, for example 0.77 to 0.83, for example 0.78 to 0.82, for example 0.79 to 0.81, for example in the magnitude of Mach 0.8, in the magnitude of Mach 0.85 or in the range of from 0.8 to 0.85. Any arbitrary speed within these ranges can be the constant cruise condition. In the case of some aircraft, the constant cruise conditions may be outside these ranges, for example below Mach 0.7 or above Mach 0.9.

Purely by way of example, the cruise conditions may correspond to standard atmospheric conditions at an altitude that is in the range from 10,000 m to 15,000 m, for example in the range from 10,000 m to 12,000 m, for example in the range from 10,400 m to 11,600 m (around 38,000 ft), for example in the range from 10,500 m to 11,500 m, for example in the range from 10,600 m to 11,400 m, for example in the range from 10,700 m (around 35,000 ft) to 11,300 m, for example in the range from 10,800 m to 11,200 m, for example in the range from 10,900 m to 11,100 m, for example of the order of 11,000 m. The cruise conditions may correspond to standard atmospheric conditions at any given altitude in these ranges.

Purely by way of example, the cruise conditions may correspond to the following: a forward Mach number of 0.8; a pressure of 23,000 Pa; and a temperature of −55 degrees C.

As used anywhere herein, “cruising speed” or “cruise conditions” may mean the aerodynamic design point. Such an aerodynamic design point (or ADP) may correspond to the conditions (including, for example, the Mach number, environmental conditions, and thrust requirement) for which the fan operation is designed. This may mean, for example, the conditions under which the fan (or the gas turbine engine) has the optimum efficiency in terms of construction.

During use, a gas turbine engine as described and claimed herein can operate at the cruise conditions defined elsewhere herein. Such cruise conditions can be determined by the cruise conditions (for example the mid-cruise conditions) of an aircraft to which at least one (for example 2 or 4) gas turbine engine can be fastened in order to provide the thrust force.

It is self-evident to a person skilled in the art that a feature or parameter described in relation to one of the above aspects can be applied to any other aspect, unless they are mutually exclusive. Furthermore, any feature or any parameter described here may be applied to any aspect and/or combined with any other feature or parameter described here, unless these are mutually exclusive.

Embodiments will now be described, by way of example, with reference to the figures.

In the figures:

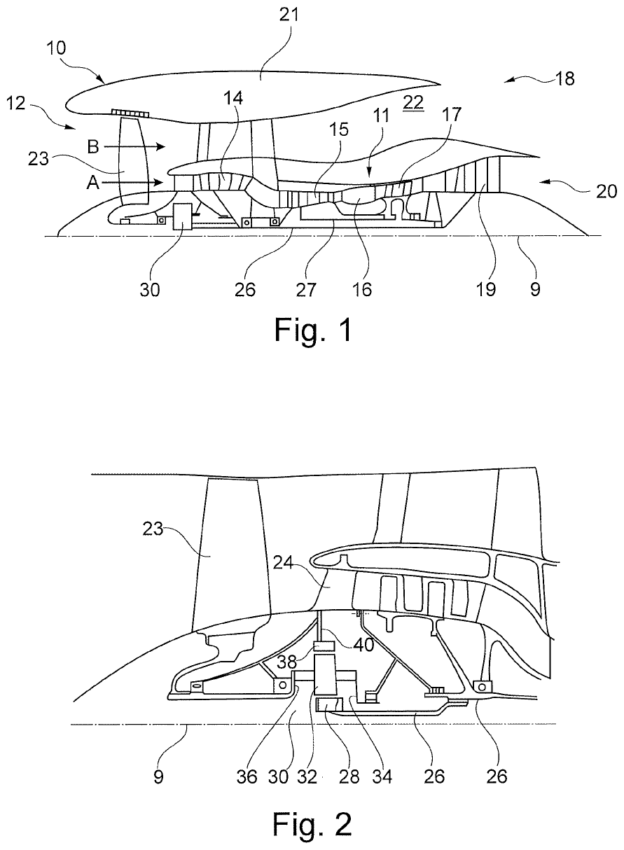

FIG. 1 shows a longitudinal sectional view of a gas turbine engine having a planetary gear box;

FIG. 2 shows an enlarged partial longitudinal sectional view of an upstream portion of a gas turbine engine;

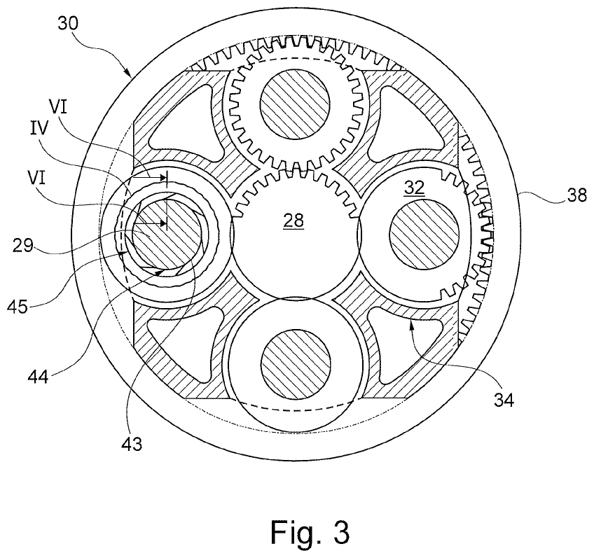

FIG. 3 shows a planetary gear box for a gas turbine engine in a standalone view;

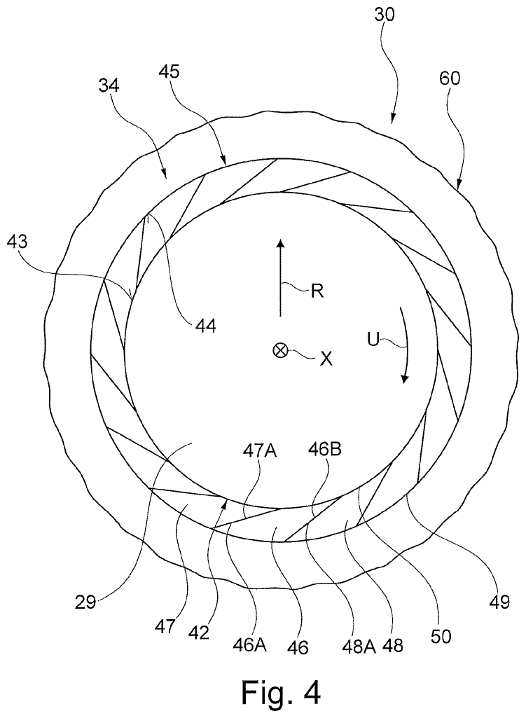

FIG. 4 shows a schematic detail illustration of a device having a ring-shaped structural unit, which is installed between a planet carrier of the planetary gear box according to FIG. 3 and a bolt which is arranged in a bore of the planet carrier;

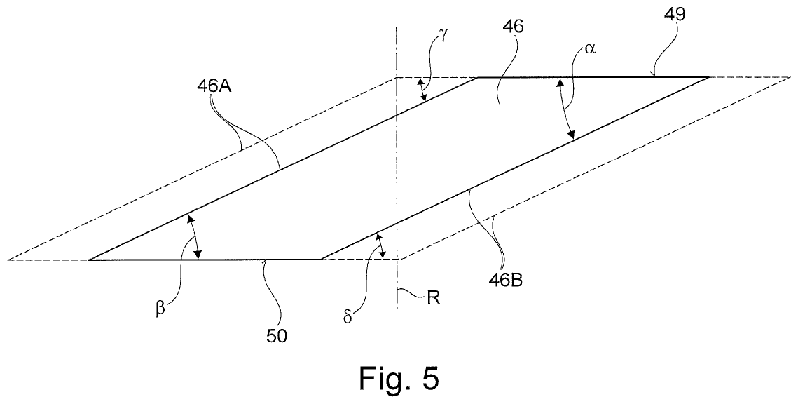

FIG. 5 shows a schematic detail view of an element of the ring-shaped structural unit as per FIG. 4;

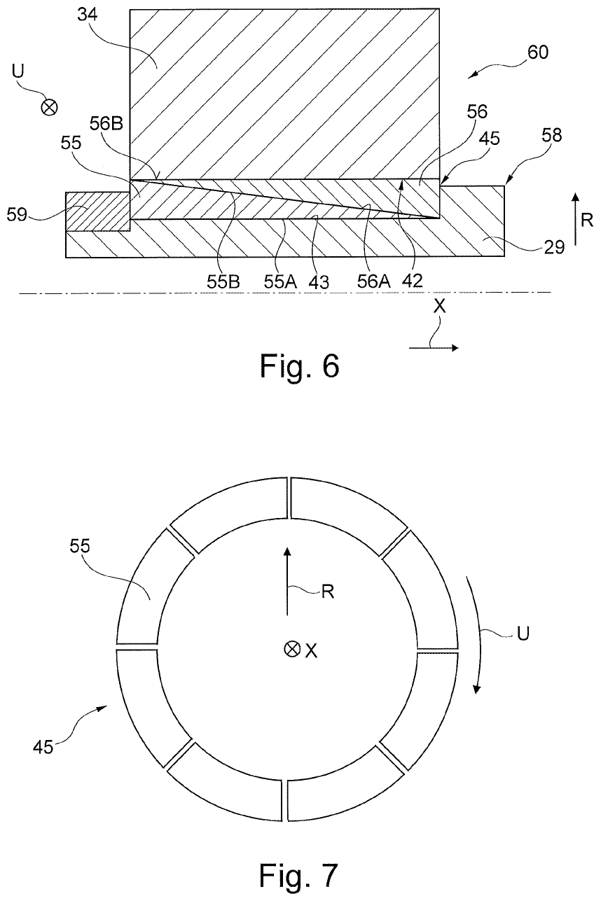

FIG. 6 shows a schematic sectional view of a further embodiment of the planetary gear box along a section line VI-VI denoted in more detail in FIG. 3;

FIG. 7 shows a simplified side view of the ring-shaped structural unit as per FIG. 6; and

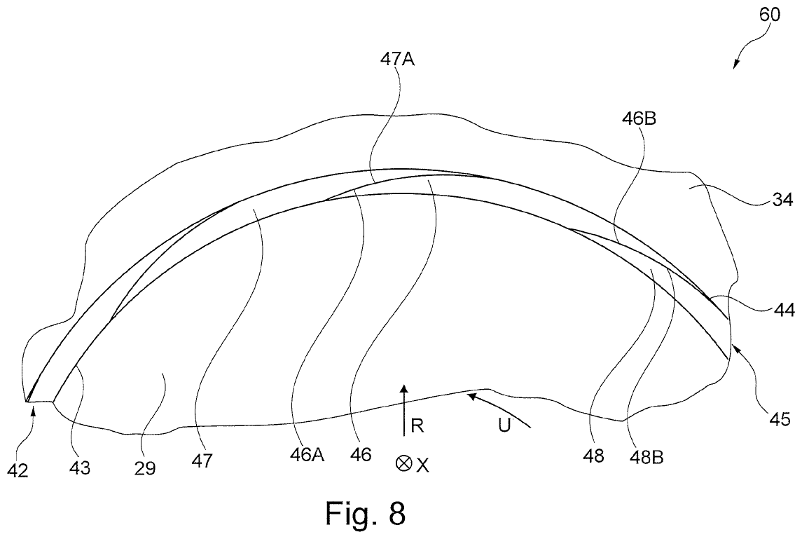

FIG. 8 shows a simplified partial illustration of a further embodiment of the device according to the present disclosure.

FIG. 1 illustrates a gas turbine engine 10 with a main axis of rotation 9. The engine 10 comprises an air intake 12 and a thrust fan 23 that generates two airflows: a core airflow A and a bypass airflow B. The gas turbine engine 10 comprises an engine core 11 that receives the core airflow A. In the sequence of axial flow, the engine core 11 comprises a low-pressure compressor 14, a high-pressure compressor 15, a combustion device 16, a high-pressure turbine 17, a low-pressure turbine 19, and a core thrust nozzle 20. An engine nacelle 21 surrounds the gas turbine engine 10 and defines a bypass duct 22 and a bypass thrust nozzle 18. The bypass airflow B flows through the bypass duct 22. The fan 23 is attached to the low-pressure turbine 19 via a shaft 26 and a planetary gear box 30 or an epicyclic gear box, and is driven by said low-pressure turbine 19. The shaft 26 herein is also referred to as the core shaft.

During use, the core airflow A is accelerated and compressed by the low-pressure compressor 14 and directed into the high-pressure compressor 15, where further compression takes place. The compressed air expelled from the high-pressure compressor 15 is directed into the combustion device 16, where it is mixed with fuel and the mixture is combusted. The resultant hot combustion products then expand through, and thereby drive, the high-pressure and low-pressure turbines 17, 19 before being discharged through the core thrust nozzle 20 in order to provide a certain thrust force. The high-pressure turbine 17 drives the high-pressure compressor 15 by way of a suitable connecting shaft 27, which is also referred to as the core shaft. The fan 23 generally provides the majority of the propulsion force. The planetary gear box 30 is a reduction gear box.

An exemplary arrangement for a geared fan gas turbine engine 10 is shown in FIG. 2. The low-pressure turbine 19 drives the shaft 26 which is coupled to a sun gear 28 of the planetary gear box 30. Multiple planet gears 32A to 32D, which are illustrated in more detail in FIG. 3 and which are coupled to one another by means of a planet carrier 34, are situated radially outside the sun gear 28 and mesh with the latter, and are in each case arranged so as to be rotatable on carrier elements 29 which are connected in a rotationally fixed manner to the planet carrier 34. The planet carrier 34 restricts the planet gears 32A to 32D to orbiting in a synchronized manner about the sun gear 28, while said planet carrier 34 enables each planetary gear 32A to 32D to rotate about its own axis on the carrier elements 29. The planet carrier 34 is coupled by way of linkages 36 to the fan 23 so as to drive the rotation of the latter about the engine axis 9. An external gear or ring gear 38, which is coupled by means of linkages 40 to a static, rotationally fixed support structure 24, is situated radially to the outside of the planet gears 32A to 32D and meshes therewith.

It is noted that the terms “low-pressure turbine” and “low-pressure compressor” as used herein can be taken to mean the lowest pressure turbine stage and the lowest pressure compressor stage (that is to say not including the fan 23) respectively and/or the turbine and compressor stages that are connected to one another by the connecting shaft 26 with the lowest rotational speed in the engine (that is to say not including the gear box output shaft that drives the fan 23). In some documents, the “low-pressure turbine” and the “low-pressure compressor” referred to herein may alternatively be known as the “intermediate-pressure turbine” and “intermediate-pressure compressor”. Where such alternative nomenclature is used, the fan 23 can be referred to as a first compression stage or lowest-pressure compression stage.

The planetary gear box 30 is shown in more detail in an exemplary manner in FIG. 3. The sun gear 28, the planet gears 32A to 32D and the ring gear 38 each comprise teeth around the periphery thereof for the purposes of meshing with the other toothed gears. Although four planet gears 32A to 32D are illustrated, it will be apparent to the person skilled in the art that more or fewer than four planet gears can be provided within the scope of protection of the claimed invention. Practical applications of a planetary gear box 30 generally comprise at least three planet gears.

The epicyclic gear box 30 illustrated by way of example in FIGS. 2 and 3 is a planetary gear box in which the planet carrier 34 is coupled by means of linkages 36 to an output shaft, wherein the ring gear 38 is fixed to the housing. However, any other suitable type of epicyclic gear box 30 can be used. As a further example, the epicyclic gear box 30 can have a star arrangement in which the planet carrier 34 is held rotationally fixed and the ring gear 38 is rotatable. In the case of such an arrangement, the fan 23 is driven by the ring gear 38. As a further alternative example, the gear box 30 can be a differential gear box in which both the ring gear 38 and the planet carrier 34 are allowed to rotate.

It will be appreciated that the arrangement shown in FIGS. 2 and 3 is merely exemplary, and various alternatives fall within the scope of protection of the present disclosure. Purely by way of example, any suitable arrangement can be used for positioning the planetary gear box 30 in the gas turbine engine 10 and/or for connecting the planetary gear box 30 to the gas turbine engine 10. By way of further example, the connections (for example the linkages 36, 40 in the example of FIG. 2) between the planetary gear box 30 and other parts of the engine 10 (such as, for example, the input shaft 26, the output shaft, and the fixed structure 24) can have a certain degree of stiffness or flexibility. By way of further example, any suitable arrangement of the bearings between rotating and stationary parts of the engine (for example between the input and output shafts of the planetary gear box and the fixed structures, such as, for example, the gear box casing) can be used, and the disclosure is not limited to the exemplary arrangement of FIG. 2. For example, where the planetary gear box 30 has a star arrangement (described above), the skilled person would readily understand that the arrangement of output and support linkages and bearing positions would generally be different to those shown in an exemplary manner in FIG. 2.

Accordingly, the present disclosure extends to a gas turbine engine having an arbitrary arrangement of gear box types (for example star-shaped or planetary), support structures, input and output shaft arrangement, and bearing positions.

Optionally, the gear box can drive additional and/or alternative components (for example the intermediate-pressure compressor and/or a booster compressor).

Other gas turbine engines in which the present disclosure can be used can have alternative configurations. For example, such engines may have an alternative number of compressors and/or turbines and/or an alternative number of connecting shafts. By way of further example, the gas turbine engine shown in FIG. 1 has a split flow nozzle 20, 22, meaning that the flow through the bypass duct 22 has a dedicated nozzle that is separate from and radially outside the engine core nozzle 20. However, this is not restrictive, and any aspect of the present disclosure can also apply to engines in which the flow through the bypass duct 22 and the flow through the core 11 are mixed or combined before (or upstream of) a single nozzle, which can be referred to as a mixed flow nozzle. One or both nozzles (whether mixed or split flow) can have a fixed or variable region. Although the example described relates to a turbofan engine, the disclosure can be applied, for example, to any type of gas turbine engine, such as, for example, an open rotor engine (in which the fan stage is not surrounded by an engine nacelle) or a turboprop engine.

The geometry of the gas turbine engine 10, and components thereof, is or are defined using a conventional axis system which comprises an axial direction (which is aligned with the axis of rotation 9), a radial direction (in the direction from bottom to top in FIG. 1), and a circumferential direction (perpendicular to the view in FIG. 1). The axial, radial and circumferential directions run so as to be mutually perpendicular.

FIG. 4 shows an enlarged view of a region IV denoted in more detail in FIG. 3, which region constitutes a region of a device 60 of the planetary gear box 30. The device 60 comprises the planet carrier 34 and the carrier elements 29 which are connected rotationally fixedly to said planet carrier and which are designed as bolts. The carrier element 29 illustrated in FIG. 4 is arranged with a cylindrical region in a bore 42 of the planet carrier 34. Between an outer side 43 of the carrier element 29 and an inner side 44 of the bore 42, there is installed a substantially ring-shaped structural unit 45, by means of which the rotationally fixed connection between the planet carrier 34 and the carrier element 29 is produced. Here, the planet carrier 34 engages in certain regions radially around the component, or the carrier element 29, in an axial direction X of the planet carrier 34 and of the carrier element 29.

The ring-shaped structural unit 45 comprises multiple elements 46, which extend in a circumferential direction U of the planetary gear box 30 radially between the carrier element 29 and the planet carrier 34. Here, the inner diameter of the bore 42 of the planet carrier 34 and the outer diameter of the outer side 43 of the carrier element 29 are adapted to the outer diameter of the structural unit 45 and to the inner diameter of the structural unit 45 respectively, such that an interference fit is present in each case between the radially inner carrier element 29 and the structural unit 45 and between the radially outer planet carrier 34 and the structural unit 45 over the entire operating range of the planetary gear box 30, by means of which interference fit the rotationally fixed operative connection between the carrier element 29 and the planet carrier 34 is ensured.

In the exemplary embodiment of the planetary gear box 30 illustrated in FIG. 4, the elements 46 to 48 bear against one another in the region of mutually facing circumferential end sides 46A and 47A, and 46B and 48B, respectively. The end sides 46A to 48B of the elements 46 to 48 enclose in each case an angle α, γ with an outer side 49, or radial end side, respectively, of the structural unit 45. Furthermore, the end sides 46A to 48B enclose in each case an angle β, δ with an inner side 50 or radial end side of the structural unit 45. In other words, the end sides 46A to 48B enclose the angles α, β, γ, δ in each case with the tangent to the outer side 49 or to the inner side 50. As an alternative to this, it is also possible for the inclination of the wedge-shaped ends of the elements 46 to 48 to be defined in a manner dependent on the angle between the end sides 46A to 48B and the radial extent direction R of the structural unit 45.

The ring-shaped structural unit 45, or the elements 46 to 48 thereof, are produced from a material, for example steel, which has a considerably greater coefficient of thermal expansion than the material of the planet carrier 34 and than the material of the carrier element 29, which may both likewise be produced from steel. It is thus ensured that, during the assembly of the planetary gear box 30, smaller temperature differences and/or pressing-in forces are required than in the case of solutions known from the prior art in order to push the ring-shaped structural unit 45 between the components that are to be connected rotationally fixedly to one another, that is to say between the planet carrier 34 and the carrier element 29.

Since a not inconsiderable temperature increase in relation to the assembly situation of the planetary gear box 30 occurs during the operation of the gas turbine engine 10, the elements 46 to 48 of the structural unit 45 expand to a much greater extent than the planet carrier 34 and the carrier element 29. Owing to the wedge shape in the region of their circumferential end sides 46A to 48B, the elements 46 to 48 slide into one another in the circumferential direction and thus generate a joining pressure between the inner side 44 of the bore 42 and the outer side 49 of the structural unit 45 and between the inner side 50 of the structural unit 45 and the outer side 43 of the carrier element 29. The joining pressure that arises here effects the oversize that is required in each case for the rotationally fixed connection between the planet carrier 34 and the carrier element 29.

Here, the joining pressure is significantly influenced by the wedge angles α to δ. Different wedge angles α to δ of the elements 46 to 48 give rise, in the circumferential direction of the structural unit 45, to a non-uniform profile of the joining pressure between the planet carrier 34 and the structural unit 45 and between the structural unit 45 and the carrier element 29. For this reason, the configuration of the wedge angles α to δ is dependent on the manner in which the joining pressure is to be distributed in the circumferential direction in a manner dependent on the respectively present usage situation. Here, it is possible for the joining pressure to be set so as to be constant, so as to increase or decrease, and/or so as to fluctuate, in the circumferential direction. Furthermore, the wedge angles α to δ are also dependent on the number of elements 46 to 48, the length of the elements 46 to 48 in the radial direction, and the radial thickness of the elements 46 to 48.

Depending on the respectively present usage situation, the wedge angles α, β, γ and δ are predefinable in a range between 0° and 90°, preferably 10° and 80°, in order to be able to connect the carrier element 29 and the planet carrier 34 rotationally fixedly to one another to the desired degree.

Here, the stiffness of the elements 46 to 48 and thus of the structural unit 45 as a whole is greater the smaller the wedge angles α, β, γ and δ that are enclosed by the end sides 46A to 48B with the radial direction R. Furthermore, the stiffness of the elements 46 to 48 and thus of the structural unit 45 as a whole is greater the greater the wedge angles α, β, γ and δ that are enclosed by the end sides 46A to 48B with the tangents to the outer sides 49 or to the inner sides 50 respectively. By contrast to this, however, the temperature-induced clamping action of the structural unit 45 between the planet carrier 34 and the carrier element 29 decreases with increasing operating temperature of the planetary gear box 30 if the wedge angles α to δ relative to the radial direction R are smaller or relative to the tangents are greater, because then, the sliding of the elements 46 to 48 into one another occurs to a lesser degree.

Most steels have a coefficient of expansion of between 11×10⁻⁶ K⁻¹ and 13×10⁻⁶ K⁻¹. If both the carrier element 29 or the planet bolt and the planet carrier 34 have a coefficient of thermal expansion of approximately 12.3×10⁻⁶ K⁻¹, and if the structural unit 45, which constitutes a segmented ring, is formed from a material with a coefficient of thermal expansion of approximately 20×10⁻⁶ K⁻¹, then the ratio of the coefficients of thermal expansion is approximately 1 to 1.6, or has a value of approximately 0.6.

By contrast to this, metal alloys or steels also exist which have a considerably lower coefficient of thermal expansion, of approximately 3.8×10⁻⁶ K⁻¹. The use of such materials in combination with conventionally used metal alloys results in a ratio of for example 0.2 between the coefficients of thermal expansion of the carrier element 29 and of the structural unit 45, and those of the planet carrier 34 and of the structural unit 45, respectively. For the present usage situation, a ratio between the coefficients of thermal expansion in a value range from 0.1 to 0.9 is preferred.

FIG. 5 shows a highly schematic stand-alone illustration of the element 46, wherein the solid outline shows the outer dimensions of the element 46 when the component temperature of the element 46 corresponds to the installation temperature. The dotted outline of the element 46 shows the component dimensions of the element 46 during the operation of the planetary gear box 30, when the component temperature is higher than the installation temperature. It is clear from the schematic illustration in FIG. 5 that, as a result of the increase in the operating temperature of the planetary gear box 30, the elements 46 to 48 of the structural unit 45 expand substantially in the circumferential direction, and together give rise to a higher joining pressure during the operation of the planetary gear box 30 than during and directly after the installation process.

FIG. 6 shows a partial longitudinal sectional view of a further embodiment of the planetary gear box 30 along a section line VI-VI denoted in more detail in FIG. 3. In the exemplary embodiment of the planetary gear box 30 shown in FIG. 6, the ring-shaped structural unit 45 again has multiple elements 55, 56 running in the circumferential direction, which elements have a wedge-shaped profile in the axial direction X. Here, the elements 55 bear with their substantially cylindrical radial end sides or inner sides 55A against the outer side 43 of the carrier element 29. By contrast to this, the elements 56 bear with their outer sides 56B or radial end sides against the inner side 44 of the bore 42 of the planet carrier 34. In addition, radial end sides or inner sides 56A of the elements 56 face toward radial end sides or outer sides 55B of the elements 55, and bear against these without a gap.

The coefficients of thermal expansion of the elements 55 and 56 are in turn greater than the coefficients of thermal expansion of the planet carrier 34 and of the carrier element 29, whereby the rotationally fixed connection between the planet carrier 34 and the carrier element 29 can be realized, by insertion of the structural unit 45, with relatively low joining forces and also small temperature differences between the planet carrier 34 and the structural unit 45, and between the structural unit 45 and the carrier elements 29, respectively.

In order to prevent the elements 55 and 56 from sliding axially out of the press fit during the operation of the planetary gear box 30, the elements 55 and 56 are secured by axial securing units 58 and 59. Here, the axial securing unit 58 constitutes a shaft collar of the carrier element 29. The axial securing unit 59 may be designed for example as a ring-shaped disk or else as a type of shaft nut, by means of which the elements 55 and 56 are prevented from sliding out of the press fit between the planet carrier 34 and the carrier element 29.

In the circumferential direction, the circumferential end sides of the elements 55 and 56 in the circumference illustrated in FIG. 7 each enclose an angle of 0° with the radial extent direction R of the structural unit 45, and are spaced apart from one another. An expansion of the elements 55 and 56 in the circumferential direction U is thus possible without thereby significantly influencing the press fit between the planet carrier 34 and the structural unit 45, and between the structural unit 45 and the carrier element 29, respectively.

Depending on the respectively present usage situation, it is also possible for the elements 55 or 56 to be formed integrally with the carrier element 29 or with the planet carrier 34, and for the structural unit 45 to comprise in each case only the elements 55 or 56.

FIG. 8 shows an illustration, substantially corresponding to FIG. 4, of a further exemplary embodiment of the planetary gear box 30, in the case of which the circumferential end sides 46A to 48B of the elements 46 to 48 do not enclose a constant angle with the radial extent direction R of the structural unit 45. This results from the fact that the circumferential end sides 46A to 48B of the elements 46 to 48 are of arcuate form. The arcuate design of the circumferential end sides 46A to 48B makes it possible for the joining pressure between the planet carrier 34 and the structural unit 45 and between the structural unit 45 and the carrier element 29 to be configured with a greater degree of freedom, and for any changes in stiffness of the elements in the circumferential direction to be compensated, and for a constant joining pressure in the circumferential direction to thus be generated.

### LIST OF REFERENCE SIGNS

9 Main axis of rotation
10 Gas turbine engine
11 Engine core
12 Air inlet
14 Low-pressure compressor
15 High-pressure compressor
16 Combustion device
17 High-pressure turbine
18 Bypass thrust nozzle
19 Low-pressure turbine
20 Core thrust nozzle
21 Engine nacelle
22 Bypass duct
23 Thrust fan
24 Support structure
26 Shaft, connecting shaft
27 Connecting shaft
28 Sun gear
29 Carrier element
30 Planetary gear box
32A to 32D Planet gear
34 Planet carrier
36 Linkage
38 Ring gear
40 Linkage
42 Bore of the planet carrier
43 Outer side of the carrier element
44 Inner side of the bore
45 Ring-shaped structural unit
46 Element
46A, 46B Circumferential end side
47 Element
47A, 47B Circumferential end side of the element
48 Element
48B Circumferential end side
49 Outer side of the structural unit
50 Inner side of the structural unit
55 Element
55A Inner side of the element, radial end side
55B Outer side of the element, radial end side
56 Element
56A Inner side of the element, radial end side
56B Outer side of the element, radial end side
58, 59 Axial securing unit
60 Device
A Core airflow
B Bypass airflow
R Radial extent direction of the structural unit
U Circumferential direction of the structural unit
X Axial direction
α Angle
β Angle
γ Angle
δ Angle

1. A device having at least two components which are rotationally fixedly operatively connected to one another, wherein one component engages at least in certain regions radially around the other component in an axial direction of the components, and, between the components, there is provided a substantially ring-shaped structural unit by means of which the rotationally fixed connection between the components is produced, characterized in that the structural unit comprises at least two elements which extend in a circumferential direction radially between the components, wherein, by means of the structural unit, there is an interference fit between the radially outer component and the structural unit and between the radially inner component and the structural unit over the entire operating range of the device, and wherein the elements bear against one another in the region of their circumferential end sides or radial end sides facing toward one another, and the coefficient of thermal expansion or the coefficients of thermal expansion of the elements is or are greater than the coefficient of thermal expansion or the coefficients of thermal expansion of the components.

2. The device according to claim 1, wherein a ratio between the coefficients of thermal expansion of the components and of the elements lies in a value range between 0.1 and 0.9.

3. The device according to claim 1, wherein the circumferential end sides of the elements enclose in each case an angle between 0° and 90°, preferably between 10° and 80°, with a radial outer side and with a radial inner side of the structural unit.

4. The device according to claim 3, wherein the angle between the radial outer side of one of the elements and a circumferential end side of the element is equal to the angle between the radial inner side of the element and the end side.

5. The device according to claim 3, wherein the angle between the radial outer side of one of the elements and the circumferential end side of the element differs from the angle between the radial inner side of the element and the end side.

6. The device according to claim 3, wherein the angles between the circumferential end sides of the elements and the radial outer sides and between the circumferential end sides and the radial inner sides are equal.

7. The device according to claim 3, wherein the angles between the circumferential end sides of the elements and the radial outer sides and between the circumferential end sides and the radial inner sides differ from one another.

8. The device according to claim 1, wherein the structural unit comprises more than two elements, which elements bear against one another in each case in the region of end sides which face toward one another and which delimit the elements in the circumferential direction of the components or in the radial direction of the structural unit.

9. The device according to claim 1, wherein the circumferential end sides of the elements, at least in certain regions in the radial extent direction of the elements between the radial inner side and the radial outer side, have an arcuate profile at least in certain regions.

10. The device according to claim 1, wherein the elements of the structural unit, in the region of their radial outer sides and/or in the region of their radial inner sides, which in each case constitute radial end sides of the elements, have a wedge-shaped cross-sectional profile in the axial direction.

11. The device according to claim 1, wherein one of the components is a planet carrier of a planetary gear box and the other component, connected rotationally fixedly thereto, is a bolt on which planet gears of the planetary gear box can be arranged in a rotatable manner and which is arranged in a bore of the planet carrier, wherein the ring-shaped structural unit is arranged radially between the planet carrier and the bolt.

12. A planetary gear box having a device according to claim 1.

13. A method for producing a rotationally fixed connection between two components, having the following method steps:
introducing the first component in an axial direction of the components into a bore of the second component;
installing a ring-shaped structural unit according to claim 1 in the axial direction of the components into the bore of the second component, wherein the ring-shaped structural unit is introduced before the first component, after the first component, or at the same time as the first component, into the bore of the second component.

14. The method according to claim 13, wherein the component temperature of the second component is raised in relation to an ambient temperature before the introduction of the first component and of the structural unit into the bore, and/or the component temperature of the structural unit and/or the component temperature of the first component is lowered in relation to the ambient temperature.

15. A gas turbine engine for an aircraft, said gas turbine engine comprising the following:
an engine core which comprises a turbine, a compressor, and a core shaft that connects the turbine to the compressor;
a fan which is positioned upstream of the engine core, and
a planetary gear box which receives an input from the core shaft and outputs drive for the fan so as to drive the fan at a lower rotational speed than the core shaft, wherein the planetary gear box is designed according to claim 12.

16. The gas turbine engine according to claim 15, wherein the turbine is a first turbine, the compressor is a first compressor, and the core shaft is a first core shaft;
the engine core furthermore comprises a second turbine, a second compressor and a second core shaft which connects the second turbine to the second compressor; and
the second turbine, the second compressor and the second core shaft are arranged so as to rotate at a higher rotational speed than the first core shaft.
